(19) United States
(12) Patent Application Publication
(10) Pub. No.: US 2011/0239738 A1
(43) Pub. Date: Oct. 6, 2011

(54) APPARATUS AND METHOD FOR ANALYZING OUT-GASSING OF MOLECULAR CONTAMINANTS FROM A SAMPLE

(75) Inventors: Theo H.J. Bisschops, Eindhoven (NL); Pieter Klaas De Boxx, Eindhoven (NL); Paul V.E. Krusemann, Eindhoven (NL); Ruud Joha Theodorus Soers, Eindhoven (NL)

(73) Assignee: KONINKLIJKE PHILIPS ELECTRONICS N.V., EINDHOVEN (NL)

(21) Appl. No.: 13/133,455

(22) PCT Filed: Dec. 1, 2009
(86) PCT No.: PCT/IB09/55435

§ 371 Date: Jun. 8, 2011

(30) Foreign Application Priority Data
Dec. 8, 2008 (EP) 08170950.3

(51) Int. Cl. G01N 30/04; G01N 1/22

(52) U.S. Cl. 73/23.42; 73/23.2

(57) ABSTRACT

The invention relates to an apparatus (100, 200) and method for analyzing out-gassing of molecular contaminants (22) from a sample (2). The apparatus (100, 200) comprises a low pressure chamber (1) for accommodating the sample (2), wherein the pressure inside the low pressure chamber (1) is between 10⁻³ mbar and 10 mbar. Furthermore, the apparatus (100, 200) comprises a means (4, 5, 7, 9) for providing a laminar gas flow (12, 33, 34) in the low pressure chamber (1) wherein a first part of the gas flow (13, 35) captures and transports molecular contaminants (22) out-gassed from the sample (2), and a means (3, 40) at a first location downstream from the sample (2) for receiving the first part (13, 35) of the gas flow. An analyzer (3) analyzes the contents of the first part (13, 35) of the gas flow.

### FIELD OF THE INVENTION

The invention relates to an apparatus and a method for analyzing out-gassing of molecular contaminants from a sample.

### BACKGROUND OF THE INVENTION

The control of the level of molecular contamination of components and devices that are used in an environment requiring extreme cleanliness, such as aerospace and advanced semiconductor processing, is critical to successful manufacturing. For example, the use of very short wavelengths in Extreme Ultraviolet (EUV) lithography increases the photo-chemical decomposition and subsequent deposition of contaminants on optical components and devices in an EUV lithography apparatus. This results in yield loss and a shortened lifetime and reduced long-term device reliability of the EUV lithography apparatus. Therefore, very strict specifications on the out-gassing rate of molecular contaminants are imposed on these components. For example, the maximum allowed out-gassing rate of Silicon compounds in EUV lithography is in the order of 10⁻¹⁵ mbar·1/sec for (sub-) assemblies.

Qualification of the out-gassing rate of components can be done with Residual Gas Analysis (RGA), a technique that is based on quadrupole mass spectrometry and that is used for identifying gases present in vacuum environments. The detection limit of the out-gassing rate using RGA is not sufficient to enable an accurate measurement of the required maximum out-gassing rates of components that are used in an environment requiring extreme cleanliness, such as EUV lithography. Another factor that influences the accuracy of this measurement is out-gassing of the measurement equipment itself. In particular for large components for which a load-lock is impracticable, the component or sample, which has to be analyzed, is loaded into the RGA measurement equipment in atmospheric conditions, thereby exposing the inner surface of the measurement equipment to atmospheric conditions. This causes contamination of the inner surface of the measurement equipment with, for example, organic species, resulting in out-gassing rates of the inner surface of the measurement equipment which can be in the order of 10⁻⁹ mbar·1/sec, thereby interfering with the out-gassing of the sample that has to be analyzed. Thus, the accuracy of determining the out-gassing characteristics of the sample is negatively influenced by the out-gassing of the measurement equipment itself

### SUMMARY OF THE INVENTION

It is an object of the invention to provide an apparatus for analyzing the out-gassing of molecular contaminants from a sample with an improved accuracy. The invention is defined by the independent claims. Advantageous embodiments are defined by the dependent claims.

This object is achieved by providing an apparatus for analyzing out-gassing of molecular contaminants from a sample, wherein the apparatus comprises:
a low pressure chamber for accommodating the sample, wherein the pressure inside the low pressure chamber is between 10-3 mbar and 10 mbar;
a means for providing a laminar gas flow in the low pressure chamber wherein a first part of the gas flow captures and transports molecular contaminants out-gassed from the sample;
a means at a first location downstream from the sample for receiving the first part of the gas flow; and
an analyzer for analyzing the contents of the first part of the gas flow.

By providing a gas flow inside the low pressure chamber that is laminar, the mixing of molecular contaminants out-gassed from the inner surface of the low pressure chamber with the molecular contaminants out-gassed from the sample is minimized. The gas flow comprises a carrier gas species that is suitable for the purpose of capturing and transporting out-gassed molecular contaminants, such as for example Helium or Argon. A further reduction of this mixing is achieved by providing a pressure inside the low pressure chamber that is higher than 10-3 mbar, at which pressure the mean free path of the out-gassed molecular contaminants is small enough to minimize this mixing to a sufficient level in most practical cases, because the mean free path is inversely proportional to the pressure. The mean free path of the out-gassed molecular contaminants is typically in the order of 50 mm at 10-3 mbar depending, amongst others, on the type of molecular contaminants. Thus the mean free path of the out-gassed molecular contaminants is not larger than approximately 50 mm thereby minimizing the amount of mixing of molecular contaminants out-gassed from the sample with other out-gassed molecular contaminants, such as those out-gassed from the inner surface of the low pressure chamber.

A first part of the laminar gas flow inside the low pressure chamber flows over the sample and the molecular contaminants that out-gas from the sample are captured and are transported by this first part of the gas flow to a means that receives this first part of the gas flow. The mean free path of the molecular contaminants out-gassed from the sample should be large enough to provide for the capturing of these out-gassed molecular contaminants by the first part of the laminar gas flow that flows over the sample and thus comprises molecular contaminants out-gassed from the sample. This is achieved by providing a pressure inside the low pressure chamber that is lower than 10 mbar, at which pressure the mean free path of the out-gassed molecular contaminants is large enough to maximize the capture rate by the laminar gas flow of out-gassed molecular contaminants. The mean free path of the out-gassed molecular contaminants is typically in the order of 5 μm at 10 mbar depending, amongst others, on the type of molecular contaminants. Thus the mean free path is not smaller than approximately 5 μm to maximize the capturing efficiency of out-gassed molecular contaminants by the laminar gas flow. Thus, for the pressure range according to the invention, which is between 10-3 mbar and 10 mbar, the mean free path of the out-gassed molecular contaminants typically ranges between approximately 5 μm and 50 mm depending, amongst others, on the type of molecular contaminants.

According to the invention the molecular contaminants out-gassed from the sample are captured and collected by the first part of the gas flow. The first part of the gas flow thus does not comprise or comprises only a minimized amount of the molecular contaminants that are out-gassed from the inner surface of the low pressure chamber. In this way, the analysis of the out-gassing characteristics of the sample is not influenced or only influenced to a minimized amount by the out-gassing of the inner surface of the low pressure chamber or by other unwanted out-gassed molecular contaminants that are not originating from the sample, thus improving the accuracy of the analysis of the out-gassing of the sample. The invention provides for capturing of a substantial part of the molecular contaminants out-gassed from the sample by setting the appropriate pressure inside the low pressure chamber. This pressure range ensures that the mean free path of the molecular contaminants out-gassed from the sample, on the one hand, is high enough to achieve an increased capturing efficiency of these molecular contaminants and, on the other hand, is small enough to achieve a minimized mixing of the molecular contaminants out-gassed from the sample with molecular contaminants out-gassed from other devices or components than the sample, such as for example the inner surface of the walls of the low pressure chamber. After receiving the first part of the gas flow comprising the molecular contaminants out-gassed from the sample, an analyzer is used to analyze the contents and characteristics of the out-gassed molecular contaminants that are present in the first part of the gas flow.

In an embodiment of the apparatus according to the invention, the pressure inside the low pressure chamber is between 10-2 mbar and 1 mbar. This further improves the accuracy of the analysis of the out-gassing of molecular contaminants from a sample, because for this pressure range the mean free path of the out-gassed molecular contaminants typically ranges between approximately 50 μm and 5 mm depending, amongst others, on the type of molecular contaminants. This pressure and mean free path range further increases the capturing efficiency of the molecular contaminants out-gassed from the sample and further reduces the mixing of the molecular contaminants out-gassed from the sample with molecular contaminants out-gassed from devices or components other than the sample.

In an embodiment of the apparatus according to the invention, the apparatus further comprises a means at a second location downstream along the inner surface of the low pressure chamber for receiving a second part of the gas flow, which second part captures and transports molecular contaminants out-gassed from the inner surface of the low pressure chamber. In this way the laminar gas flow is split into a first part which mainly comprises molecular contaminants out-gassed from the sample and a second part which mainly transports molecular contaminants out-gassed from the inner surface of the low pressure chamber. Thus, the first part of the gas flow does not contain or comprises and transports only a minimized amount of molecular contaminants out-gassed from the inner surface of the low pressure chamber, and the second part of the gas flow does not contain or comprises only a minimized amount of molecular contaminants out-gassed from the sample. By splitting the laminar gas flow in this way, it is achieved that the molecular contaminants out-gassed from the sample are transported to and received by the analyzer and that the molecular contaminants out-gassed from the inner surface of the low pressure chamber or from other parts of the measurement equipment are not or only to a minimized extent, transported to and received by the analyzer, because the molecular contaminants out-gassed from the inner surface of the low pressure chamber are received at a second location downstream, which second location is different from the first location where the molecular contaminants of the sample are received. The second part of the gas flow thus captures molecular contaminants that out-gas from the inner surface of the low pressure chamber, thereby reducing the number of these molecular contaminants that reach the first part of the gas flow and reducing the mixing of molecular contaminants out-gassed from the sample with molecular contaminants out-gassed from the inner surface of the low pressure chamber.

In an embodiment of the apparatus according to the invention, the apparatus further comprises a pre-concentration device at a third location downstream from the sample for separating the out-gassed molecular contaminants from the first part of the gas flow and for collecting the out-gassed molecular contaminants during a period of time. Extremely low out-gassing rates, such as those of components or samples used in environments requiring extreme cleanliness, such as for example in semiconductor manufacturing, may profit from the use of pre-concentration devices to provide for enough material for the analysis. The pre-concentration device captures the molecular contaminants and separates these molecular contaminants from the carrier gas that is comprised in the gas flow. The pre-concentration device collects the molecular contaminants during a time period, which time period depends, amongst others, on the out-gassing rate of the molecular contaminants. In this way the accuracy of the analysis of the out-gassing is further improved, because the detection limit of the amount of out-gassed molecular contaminants decreases, and thus improves, as a function of an increase of the time period during which the pre-concentration device has collected the molecular contaminants. In a further embodiment the apparatus further comprises means for heating the pre-concentration device. Increasing the temperature of the pre-concentration device provides for the release of the molecular contaminants from the pre-concentration device, after which the released molecular contaminants are characterized in the analyzer. In this way, it is not required to move the pre-concentration device from the low pressure chamber to another location and the analysis of the out-gassed molecular contaminants can be done in-situ. Also, this embodiment allows for in-situ cleaning of the pre-concentration device before an out-gassing measurement starts.

In an embodiment of the apparatus according to the invention, the apparatus further comprises an isolation valve for separating the low pressure chamber into a first part for accommodating the sample, which first part comprises the means for providing the laminar gas flow in the low pressure chamber, and a second part which comprises the means for receiving the first part of the gas flow. By closing the isolation valve during the loading of the sample into the first part of the low pressure chamber, the second part of the low pressure chamber is not exposed to atmospheric conditions, thereby avoiding an increase of the contamination of the second part of low pressure chamber and reducing the overall contamination of the inside of the low pressure chamber.

In an embodiment of the apparatus according to the invention, the means for providing the laminar gas flow in the low pressure chamber comprises a first inlet for supplying the gas flow into the low pressure chamber and a set of vanes for making the gas flow laminar. This is a convenient way to smooth out a turbulent gas flow and to provide for a laminar gas flow inside the low pressure chamber. In a further embodiment the first inlet is for supplying the first part of the gas flow and the apparatus further comprises a second inlet in the low pressure chamber for supplying the second part of the gas flow into the low pressure chamber. In this way the gas flow is already split at the first and the second inlet into two separate gas flows, one flowing along or parallel to the inner surface of the walls of the low pressure chamber and capturing and transporting the corresponding molecular contaminants and the other flowing over the surfaces of the sample and capturing and transporting the molecular contaminants out-gassed from the sample. Here, also vanes may be used to smooth out a turbulent gas flow.

In an embodiment of the apparatus according to the invention, the means at a location downstream from the sample for receiving the first part of the gas flow comprises a funnel. The funnel provides for an efficient way of receiving the part of the gas flow that comprises the molecular contaminants out-gassed from the sample. Furthermore, the funnel provides for a shield against the molecular contaminants out-gassed from the inner surface of the low pressure chamber, thereby reducing the mixing of the molecular contaminants out-gassed from the sample with the molecular contaminants out-gassed from the inner surface of the low pressure chamber.

In an embodiment of the apparatus according to the invention, the analyzer comprises a detector suitable for detecting a specific element in the gas flow. Detectors that are sensitive to specific elements or classes of compounds can be very helpful in locating the source of specific contaminants. Furthermore, these detectors further increase the accuracy of determining the out-gassing characteristics of the sample. This enables the identification of compounds containing specific target elements. In a further embodiment the detector is an Atomic Emission Detector (AED).

The object is also achieved by a method for analyzing out-gassing of molecular contaminants from a sample, wherein the method comprises the steps of:
a) accommodating the sample in a low pressure chamber,
b) providing a pressure inside the low pressure chamber of between 10⁻³ mbar and 10 mbar;
c) providing a laminar gas flow in the low pressure chamber having a first part that captures and transports molecular contaminants out-gassed from the sample;
d) receiving a first part of the gas flow at a first location downstream from the sample; and
e) analyzing the contents of the first part of the gas flow.

In an embodiment of the method according to the invention, the step c) comprises the step of providing the first part of the gas flow and a second part of the gas flow that captures and transports molecular contaminants out-gassed from the inner surface of the low pressure chamber. The amount of mixing of the molecular contaminants out-gassed from the sample with molecular contaminants out-gassed from the inner surface of the low pressure chamber is in this way reduced, because there is a separate gas flow that captures and transports the molecular contaminants out-gassed from the inner surface of the low pressure chamber.

### BRIEF DESCRIPTION OF THE DRAWINGS

FIG. 1 shows schematically a cross-section of an embodiment of the apparatus according to the invention; and

FIG. 2 shows schematically a cross-section of another embodiment of the apparatus according to the invention.

Like reference numbers refer in the Figures to identical or similar components.

### DETAILED DESCRIPTION OF EMBODIMENTS

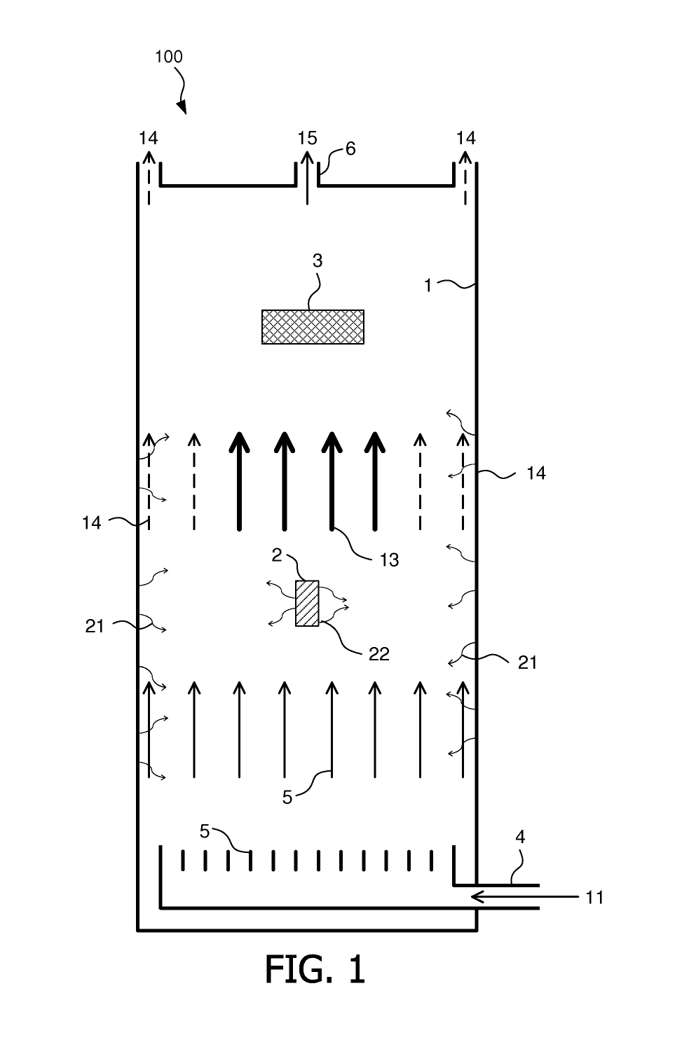

FIG. 1 shows a schematic cross-section of an apparatus 100 according to an embodiment of the invention. The apparatus 100 comprises a chamber 1 of which the inside is set at a low pressure, between 10-3 mbar and 10 mbar, preferably between 10-2 mbar and 1 mbar, by using conventional pumping methods and devices that are not shown in FIG. 1. In the chamber 1 a sample 2 is loaded and accommodated. For example the sample 2 is loaded on a chuck or any other device suitable for holding and accommodating the sample 2 on a fixed position inside the apparatus 100 (not shown). The chamber 1 comprises an inlet 4 for supplying a gas flow 11 into the chamber 1 comprising a carrier gas suitable for capturing and transporting out-gassed molecular contaminants, such as for example Helium or Argon. The gas flow 11 is converted into a laminar gas flow 12 via, in this example, a set of vanes 5, which smoothes out any turbulence in the gas flow 11. The laminar gas flow 12 in this case flows through the whole inside volume of the chamber 1 and its direction is mainly parallel to the walls of the chamber 1. As is illustrated in FIG. 1 with coiling arrows 21, 22, the inner surface of the walls of the chamber 1 out-gas wall molecular contaminants 21 and the sample 2 produces via out-gassing sample molecular contaminants 22. A part of the laminar gas flow 12 flows along the inner surface of the walls of the chamber 1 and in this way captures the out-gassed wall contaminants 21. These contaminants 21 are transported via a laminar wall gas flow 14 further downstream, while the laminar wall gas flow 14 also captures wall contaminants 21 that are out-gassed further downstream. Another part of the gas flow 12 flows over the sample 2 and in this way captures the out-gassed sample molecular contaminants 22. A laminar sample gas flow 13 then transports these out-gassed sample contaminants 22 further downstream from the sample 2. At a certain location downstream of the sample 2 the laminar sample gas flow 13 will reach an analyzer 3 which receives and collects the sample molecular contaminants 22 that are transported by the laminar sample gas flow 13. The laminar wall gas flow 14, which comprises the wall molecular contaminants 21, does not reach the analyzer 3. Hence, the analyzer 3 mainly captures sample molecular contaminants 22 out-gassed from the sample 2. The analyzer 3 is able to analyze the contents of the molecular contaminants 22 that are captured by the analyzer 3 and thus provides for the analysis of the out-gassing characteristics of the sample 2. For example, the analyzer 3 may comprise an element specific detector, such as an Atomic Emission Detector (AED), to analyze the amount of a specific element present in the sample molecular contaminants 22. The gas flow 14 and a gas flow 15, which is the remaining part of the gas flow 13 without the sample molecular contaminants 22, exit via outlets 6 for example by a pump (not shown).

The pressure inside the chamber 1 determines the mean free path of the out-gassed molecular contaminants 21, 22. The mean free path of the out-gassed molecular contaminants 21, 22 should be large enough to maximize the amount of sample molecular contaminants 22 that is captured by the laminar gas flow 12 and should also be small enough to minimize the amount of mixing between the wall molecular contaminants 21 and the sample molecular contaminants 22. The amount of sample molecular contaminants 22 captured by the laminar gas flow 12 should be maximum to get an accurate analysis of the out-gassing rate of the sample 2. Ideally all out-gassed sample molecular contaminants 22 are captured by the laminar gas flow 12 and transported by the laminar sample gas flow 13 to the analyzer 3. The amount of mixing between the wall molecular contaminants 21 and the sample molecular contaminants 22 should be minimal, because any mixing disturbs the analysis of the out-gassing characteristics of the sample 2. If the mean free path is too large, a part of the wall molecular contaminants 21 is also captured by the part of the laminar gas flow 12 that flows over the sample 2. In that case the laminar sample gas flow 13 not only transports sample molecular contaminants 22, but also wall molecular contaminants 21. Furthermore, because the mean free path is too large, some of the sample molecular contaminants 22 are captured by the part of the laminar gas flow 12 that flows close to the inner surface of the chamber 1, and thus will not be captured by the part of the laminar gas flow 12 that flows over the sample 2. Thus, the laminar sample gas flow 13, in this case, does not capture all sample molecular contaminants 22 and will also comprise wall molecular contaminants 21. This results in a less accurate analysis of the out-gassing characteristics of the sample 2. According to the invention, this is prevented and improved by setting the pressure inside the low pressure chamber 1 to a value that is higher than 10-3 mbar. For this pressure range the mean free path of out-gassed molecular contaminants is small enough to minimize the mixing to a sufficient level in most practical cases, because the mean free path is inversely proportional to the pressure. The mean free path of out-gassed molecular contaminants is typically in the order of 50 mm at 10-3 mbar depending, amongst others, on the type of molecular contaminants. Thus, for this pressure range the mean free path of out-gassed molecular contaminants is not larger than approximately 50 mm thereby minimizing the amount of mixing of molecular sample contaminants 22 with the out-gassed wall molecular contaminants 21. In order to further improve the accuracy and reduce the chance of mixing, the pressure is higher than 10-2 mbar which corresponds to a mean free path which is lower than approximately 5 mm.

In order to optimize the chance of capturing out-gassed molecular contaminants, the mean free path of out-gassed molecular contaminants should be larger than approximately 5 μm, which is achieved according to the invention by setting the pressure inside the low pressure chamber 1 to a value that is lower than 10 mbar. A further increase of the capturing chance of out-gassed molecular contaminants is achieved by setting the pressure inside the low pressure chamber 1 to a value that is lower than 1 mbar, which corresponds to a mean free path of out-gassed molecular contaminants that is larger than approximately 50 μm.

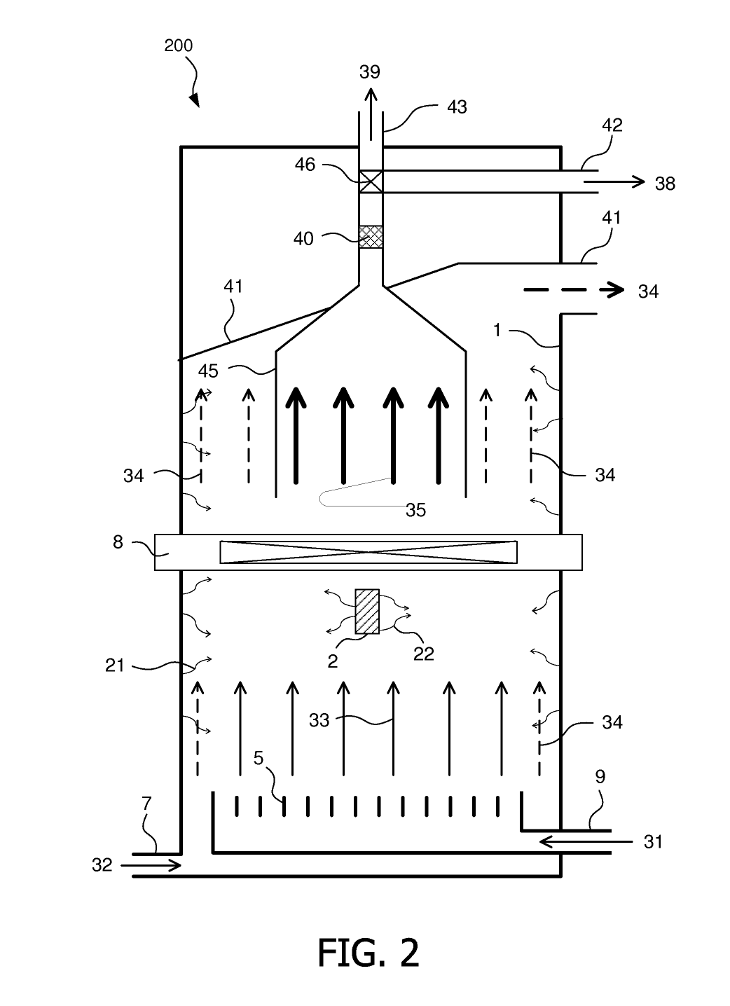

FIG. 2 shows a schematic cross-section of an apparatus 200 according to another embodiment of the invention. As is shown in FIG. 2 with the coiling arrows 21, 22, the inner surface of the walls of the chamber 1 out-gas the wall molecular contaminants 21 and the sample molecular contaminants 22 out-gas from the sample 2.

The chamber 1 is in this embodiment is split into two parts by an isolation valve 8. The isolation valve 8 is closed in case the sample 2 is loaded into a loading part of the chamber 1 thereby preventing a second part of the chamber 1 from being exposed to atmospheric conditions, which second part is set at a low pressure, between 10-3 mbar and 10 mbar, preferably between 10-2 mbar and 1 mbar, by using conventional pumping methods and devices that are not shown in FIG. 2. After loading and accommodating the sample 2 into the chamber 1, the loading part of the chamber 1 is pumped to similar low pressure conditions as the second part of the chamber 1 after which the isolation valve 8 is opened. This reduces the contamination level inside the low pressure chamber 1 and thus reduces the amount of wall molecular contaminants 21, because a part of the chamber 1 is not exposed to atmospheric conditions when the sample 2 is loaded into the chamber 1 thereby reducing the inflow into the chamber 1 of molecular contaminants that may adhere to the inner surface of the chamber 1. Additionally, the second part of the chamber 1 can be conditioned before each analysis, for example vacuum baked, to provide for a further reduction of the out-gassing rate of the inner surface of the wall of the chamber 1.

The chamber 1 comprises a first inlet 9 for supplying a first gas flow 31 into the chamber 1 comprising a carrier gas suitable for capturing and transporting out-gassed molecular contaminants, such as for example Helium or Argon. The first gas flow 31 is converted into a laminar first gas flow 33 before it reaches the sample 2 via, for example, a set of vanes 5. The vanes 5 in combination with the first inlet 9 further provide for a direction of the laminar first gas flow 33 that is towards and over the sample 2 and substantially parallel to the inner surface of the walls of the chamber 1. Furthermore, the laminar first gas flow 33 flows on such a distance from the inner walls of the chamber 1 that the wall molecular contaminants 21 are not, or only a minimum amount, captured by the laminar first gas flow 33. A second inlet 7 supplies a second gas flow 32 into the chamber 1 comprising a similar carrier gas as the first gas flow 31. The second gas flow 32 is converted into a laminar wall gas flow 34 that flows into a direction that is substantially parallel to the inner surface of the low pressure chamber 1 and on such a distance from the inner surface that the capture rate of the wall molecular contaminants 21 by the laminar wall gas flow 34 is maximized. In operation, i.e. after loading of the sample 2 and setting the appropriate pressure inside the loading part of the chamber 1, the isolation valve 8 is opened thereby setting the loading part of the chamber 1 in direct connection with the second part of the chamber 1. The laminar first gas flow 33, which flows over the sample 2, captures the out-gassed sample molecular contaminants 22 and transports the captured sample molecular contaminants 22 further downstream of the sample 2 via a sample gas flow 35. The laminar wall gas flow 34 flows along and close to the inner surface of the walls of the chamber 1 and in this way captures and transports the out-gassed wall contaminants 21 to a location further downstream. A funnel 45 is provided at a location downstream of the sample 2 and is located in the second part of the chamber 1, which second part is not exposed to atmospheric conditions when the sample 2 is loaded into the chamber 1. The funnel 45 has such a shape, for example conical, that the laminar sample gas flow 35 is received and guided to a location where the sample gas flow 35 is analyzed. The funnel 45 receives only the sample gas flow 35, comprising the out-gassed sample contaminants 22, and does not receive, or receives and captures only a minimum amount of, the laminar wall gas flow 34, comprising the out-gassed wall contaminants 21. The funnel 45 thus provides for an improved separation of the wall gas flow 34 and the sample gas flow 33 thereby reducing the mixing of the out-gassed wall molecular contaminants 21 and the out-gassed sample molecular contaminants 22 and thus increasing the accuracy of the analysis of the out-gassed sample contaminants 22. The laminar wall gas flow 34 is received by a first outlet 41 which guides the laminar wall gas flow 34 out of the chamber, for example via a pump (not shown).

In this embodiment, the sample gas flow 35 is guided by the funnel 45 to a pre-concentration device 40. The pre-concentration device 40 provides for a separation of the gas used for the laminar transport and the sample molecular contaminants 22. Furthermore, the pre-concentration device 40 captures and collects the sample molecular contaminants 22 during a certain time period. After this time period the collected sample molecular contaminants 22 are released from the pre-concentration device 40, for example by heating, in a relatively short time interval and are transported (shown by arrow 39) via a second outlet 43 to a section where the molecular contaminants 22 are analyzed (not shown). The analysis is executed for example by an element specific detector such as an AED. A second valve 46 on a location further downstream from the pre-concentration device 40, is able to switch to a first state in which the sample molecular contaminants 22 are transported via the second outlet 43 to an analyzer (not shown) after they are released from the pre-concentration device 40 and is able to switch to a second state in which an after-pre-concentration gas flow 38, which does not comprise the sample molecular contaminants 22, is transported to a third outlet 42, for example by a pump (not shown). By using a pre-concentration method, wherein the sample molecular contaminants 22 are collected with the pre-concentration device 40 during a certain time period, a larger amount of molecular contaminants 22 is available for analysis. Hence, a low out-gassing rate of the sample molecular contaminants 22 is compensated by capturing the sample molecular contaminants 22 during a certain time period such that enough sample molecular contaminants 22 are available for an analysis with an improved and acceptable accuracy. The release of the collected sample molecular contaminants 22 from the pre-concentration device 40 can be executed with standard available methods, such as for example heating of the pre-concentration device 40, after which the released sample molecular contaminants 22 can be analyzed. In this way, it is not required to unload the pre-concentration device 40 from the low pressure chamber 1 to perform the analysis at another location and the analysis of the sample molecular contaminants 22 can be done in-situ. However, in an alternative embodiment, the pre-concentration device 40 is removed from the chamber 1 to provide for an ex-situ analysis of the collected molecular contaminants 22. In that case the second outlet 43 and the switch valve 46 are not required.

Furthermore, it should be noted that, if out-gassing of the inner surface of the walls of the low pressure chamber 1 is well characterized, a separation into a laminar wall gas flow and a laminar sample gas flow is not strictly necessary. An apparatus with only one laminar gas flow is in that case another embodiment of this invention.

In summary, the invention relates to an apparatus for analyzing out-gassing of molecular contaminants from a sample. The apparatus comprises a low pressure chamber for accommodating the sample, wherein the pressure inside the low pressure chamber is between 10⁻³ mbar and 10 mbar. Furthermore, the apparatus comprises a means for providing a laminar gas flow in the low pressure chamber wherein a first part of the gas flow captures and transports molecular contaminants out-gassed from the sample, and a means at a first location downstream from the sample for collecting the first part of the gas flow. An analyzer analyzes the contents of the first part of the gas flow. In this way a more accurate analysis of the out-gassing characteristics of the sample is achieved.

A low pressure method is chosen in order to minimize the influence on the out-gassing process. Especially for large components or sub-assemblies, for which a load-lock is impracticable, a gas flow is introduced which flows over the sample to entrain and collect out-gassed species or molecular contaminants and which flows along the surface of the walls of the vacuum chamber to entrain and divert out-gassing of the surface of the walls. Layout and conditions of the gas flow should allow for a maximum entrainment of the out-gassing species from the sample and a minimal mixing between the species or molecular contaminants out-gassed from the walls and the species or molecular contaminants out-gassed from the sample.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An apparatus (100, 200) for analyzing out-gassing of molecular contaminants (22) from a sample (2), the apparatus (100, 200) comprising:
a low pressure chamber (1) for accommodating the sample (2), wherein the pressure inside the low pressure chamber (1) is between 10⁻³ mbar and 10 mbar;
a means (4, 5, 7, 9) for providing a laminar gas flow (12, 33, 34) in the low pressure chamber (1) wherein a first part of the gas flow (13, 35) captures and transports molecular contaminants (22) out-gassed from the sample (2);
a means (3, 40) at a first location downstream from the sample (2) for receiving the first part (13, 35) of the gas flow; and
an analyzer (3) for analyzing the contents of the first part (13, 35) of the gas flow.

2. An apparatus (100, 200) according to claim 1, wherein the pressure inside the low pressure chamber (1) is between 10⁻² mbar and 1 mbar.

3. An apparatus (100, 200) according to claim 1, wherein the apparatus (100, 200) further comprises a means (41) at a second location downstream along the inner surface of the low pressure chamber (1) for receiving a second part (14, 34) of the gas flow, which second part (14, 34) captures and transports molecular contaminants (21) out-gassed from the inner surface of the low pressure chamber (1).

4. An apparatus (200) according to claim 1, further comprising a pre-concentration device (40) at a third location downstream from the sample (2) for separating the out-gassed molecular contaminants (22) from the first part (13, 35) of the gas flow and for collecting the out-gassed molecular contaminants (22) during a period of time.

5. An apparatus (200) according to claim 4, further comprising means for heating the pre-concentration device (40).

6. An apparatus (200) according to claim 1, further comprising an isolation valve (8) for separating the low pressure chamber (1) into a first part for accommodating the sample (2), which first part comprises the means (4, 5, 7, 9) for providing the laminar gas flow (12, 33, 34) into the low pressure chamber (1), and a second part which comprises the means (3, 40) for receiving the first part (13, 35) of the gas flow.

7. An apparatus (100, 200) according to claim 1, wherein the means (4, 5, 7, 9) for providing the laminar gas flow (12, 33, 34) in the low pressure chamber comprises a first inlet (4, 9) for supplying the gas flow (11, 31, 32) into the low pressure chamber (1) and a set of vanes (5) for making the gas flow (11, 31, 32) laminar.

8. An apparatus (200) according to claim 7, wherein the first inlet (4, 9) is for supplying the first part of the gas flow (33) and wherein the apparatus (200) further comprises a second inlet (7) in the low pressure chamber (1) for supplying the second part of the gas flow (34) into the low pressure chamber (1).

9. An apparatus (200) according to claim 1, wherein the means (3, 40) at a location downstream from the sample (2) for receiving the first part (13, 35) of the gas flow comprises a funnel (45).

10. An apparatus (100, 200) according to claim 1, wherein the analyzer (3) comprises a detector suitable for detecting a specific element in the gas flow.

11. An apparatus (100, 200) according to claim 10, wherein the detector is an Atomic Emission Detector.

12. A method for analyzing out-gassing of molecular contaminants (22) from a sample (2), the method comprising the steps of:
a) accommodating the sample (2) in a low pressure chamber (1),
b) providing a pressure inside the low pressure chamber (1) of between 10⁻³ mbar and 10 mbar;
c) providing a laminar gas flow (12, 33, 34) in the low pressure chamber (1) having a first part (13, 35) that captures and transports molecular contaminants (22) out-gassed from the sample (2);
d) receiving the first part (13, 35) of the gas flow at a first location downstream from the sample (2); and
e) analyzing the contents of the first part (13, 35) of the gas flow.

13. A method according to claim 12, wherein, the step c) comprises the step of providing the first part of the gas flow (33) and a second part of the gas flow (34) that captures and transports molecular contaminants (21) out-gassed from the inner surface of the low pressure chamber (1).
